(19) United States
(12) Patent Application Publication
(10) Pub. No.: US 2019/0351596 A1
(43) Pub. Date: Nov. 21, 2019

(54) Molding Device for Making a Foamed Shoe Element

(71) Applicant: Pou Chen Corporation, Chang Hwa Hsien (TW)

(72) Inventors: Shih-Chia Lin, Yuanlin City (TW); Chih-Hung Ma, Chang Hwa Hsien (TW); Hung-Wu Hsieh, Xizhou Township (TW); Shao-Wei Jen, Chang Hwa Hsien (TW); Chien-Jung Hung, Chang Hwa Hsien (TW); Tsung-Wei Kuo, Changhua City (TW); Ju-Cheng Chen, Tainan City (TW)

(21) Appl. No.: 16/140,599

(22) Filed: Sep. 25, 2018

(30) Foreign Application Priority Data
May 16, 2018 (TW) 107116564

(51) Int. Cl. B29C 45/34; B29C 45/17; B29D 35/00; B29D 35/12; C08J 9/12

(52) U.S. Cl. CPC B29C 45/345; B29C 45/1706; B29L 2031/50; B29D 35/128; C08J 9/122; B29D 35/0018

(57) ABSTRACT

A molding device includes first and second molds, and a material passage. The first mold includes a first porous layer including a first porous main body, a first molding surface and a first connecting tube formed in the first porous main body. The first mold has a first gas passage for a gas to be supplied into the first porous main body. The second mold includes a second porous layer including a second porous main body, a second molding surface cooperating with the first molding surface to define a cavity, and a second connecting tube formed in the second porous main body. The material passage extends through one of the first and second molds, and is spatially communicated with the cavity for entrance of a supercritical foaming material into the cavity.

### CROSS-REFERENCE TO RELATED APPLICATION

This application claims priority of Taiwanese Invention Patent Application No. 107116564, filed on May 16, 2018.

### FIELD

The disclosure relates to a molding device for making a shoe element, and more particularly to a molding device for molding a supercritical foaming material into a foamed shoe element.

### BACKGROUND

A conventional supercritical injection molding method is used for producing foaming materials, and includes the use of pressurizing an inert gas (e.g., carbon dioxide) and mixing the inert gas with a foaming material to obtain a supercritical foaming material. Supercritical carbon dioxide has the properties of high solubility and high expansivity, and can be used to replace chemical foaming agent. The supercritical foaming material is then injected into a heated mold assembly to be molded into the plastic foam, which includes rather small gas bubbles. Compared to conventional molding technique, the supercritical injection molding method requires fewer raw materials. Therefore, it is well accepted in the market for its low cost and high product quality.

Specifically, in the supercritical injection molding method, the mold assembly is first heated, followed by introducing the inert gas into a mold cavity of the mold assembly. Then, the supercritical foaming material is injected into the mold cavity, within which the gas pressure of the inert gas in the mold cavity is greater than the supercritical pressure of the supercritical foaming material, thereby preventing the supercritical foaming material from foaming. Afterwards, the inert gas in the mold cavity is released from the mold assembly to lower the pressure applied to the supercritical foaming material, allowing the supercritical inert gas in the foaming material to transfer into gas phase to obtain the plastic foam.

However, the mold assembly has a rather complex structure and the cost of manufacturing thereof is rather expensive.

### SUMMARY

Therefore, an object of the disclosure is to provide a molding device that can alleviate the drawback of the prior art.

According to an aspect of the present disclosure, a molding device is adapted for molding a supercritical foaming material into a foamed shoe element.

The molding device includes a first mold, a second mold and a material passage. The first mold includes a first inner mold that includes a first porous layer. The first porous layer includes a first porous main body, a first molding surface located at one side of the first porous main body, and at least one first connecting tube formed in the first porous main body and having a solid tube wall defining a first fluid passage. The first mold has a first gas passage that extends from the first porous main body of the first porous layer in a direction away from the first molding surface of the first inner mold and that is adapted for a gas to be supplied into the first porous main body therethrough. The second mold includes a second inner mold that includes a second porous layer. The second porous layer includes a second porous main body, a second molding surface and at least one second connecting tube. The second molding surface is located at one side of the second porous main body, faces the first molding surface of the first porous layer of the first inner mold, and cooperates with the first molding surface to define a cavity. The at least one second connecting tube is formed in the second porous main body, and has a solid tube wall that defines a second fluid passage. The material passage extends through one of the first mold and the second mold, and is spatially communicated with the cavity for the supercritical foaming material to be injected into the cavity therethrough.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of an embodiment of a molding device according to the present disclosure;

FIG. 2 is an exploded perspective view of the embodiment;

FIG. 3 is a schematic sectional view of the embodiment, taken along line III-III of FIG. 1;

FIG. 4 is a fragmentary sectional view of FIG. 3;

FIG. 5 is a fragmentary perspective view of a first connecting tube of the embodiment including a plurality of protrusion blocks, each of which has a triangular shape;

FIG. 6 is a view similar to FIG. 5, but showing each of the protrusion blocks having a plate shape;

FIG. 7 is a view similar to FIG. 5, but showing each of the protrusion blocks having a spiral shape; and

FIG. 8 is a schematic sectional view of the embodiment, taken along line VI-VI of FIG. 1.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

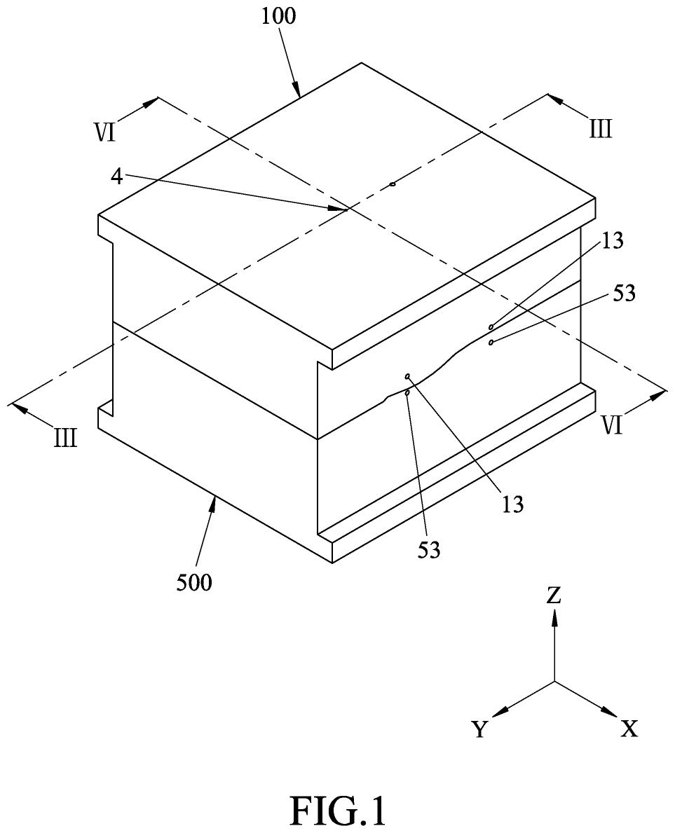

Referring to FIGS. 1 to 3, an embodiment of a molding device of the present disclosure is adapted for molding a supercritical foaming material (not shown) into a foamed shoe element 9. The molding device includes a first mold 100, a second mold 500 and a material passage 4. The first and second molds 100, 500 are interconnected detachably in a top-bottom direction (Z). In this embodiment, the supercritical foaming material includes thermoplastic polyurethane. However, it should be noted that other material may be chosen for molding according to practical requirements.

The first mold 100 includes a first mold seat 1, a first base plate 2 and a first inner mold 3. The first mold seat 1 has a first outer surface 11 that faces away from the second mold 500, and a first inner surface 12 that is opposite to the first outer surface 11 in the top-bottom direction (Z). The first mold seat 1 further has two first through holes 13 that are aligned in a front-rear direction (Y), and that each extend in a left-right direction (X). The first inner surface 12 of the first mold seat 1 is formed with a first groove 121 that is spatially communicated with the first through holes 13. The first base plate 2 is received in the first groove 121. In this embodiment, the first base plate 2 is made of steel, and possesses high rigidity and hardness.

The first inner mold 3 is made by a three dimensional printing technique from steel powder to be connected to a bottom side of the first base plate 2, and is received in the first groove 121. The first inner mold 3 includes a first porous layer 32, and a first solid layer 31 that is connected between the first base plate 2 and the first porous layer 32. In this embodiment, the first porous layer 32 has a porosity ranging from 0% to 50%. A periphery of the first porous layer 32 is connected to the first solid layer 31 such that the first solid layer 31 and the first porous layer 32 cooperatively define a first hollow space 34 therebetween. The first hollow space 34 contains air and is used for thermal insulation.

The first mold 100 further has a first gas passage 35 that extends from the first porous layer 32 in a direction away from the first inner mold 3, and that is adapted for a gas to be supplied to the first porous layer 32 therethrough. In this embodiment, the first gas passage 35 extends through the first mold seat 1, the first base plate 2 and the first solid layer 31 of the first inner mold 3 in the top-bottom direction (Z). In this embodiment, the first solid layer 31 is a dense and solid steel plate made by three dimensional printing. Gas and liquid are therefore unable to penetrate the first solid layer 31. The first porous layer 32 includes a first molding surface 33 opposite to the first solid layer 31. In this embodiment, the first inner mold 3 is disposed in the first groove 121 by the first base plate 2, which supports the first inner mold 3 to avoid buckling of the first inner mold 3. However, the first base plate 2 may be omitted according to practical requirements.

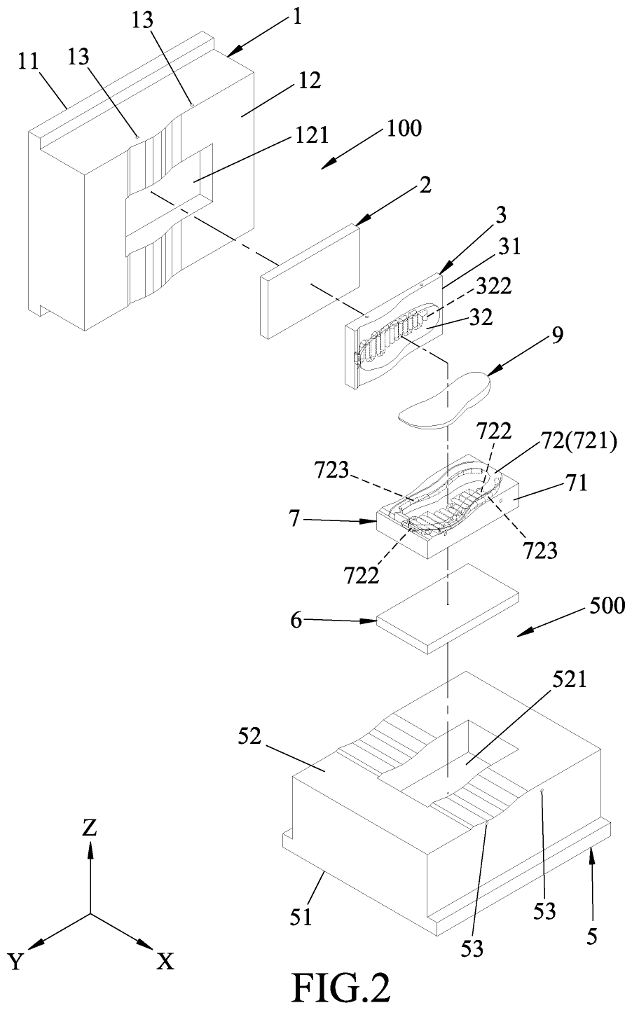

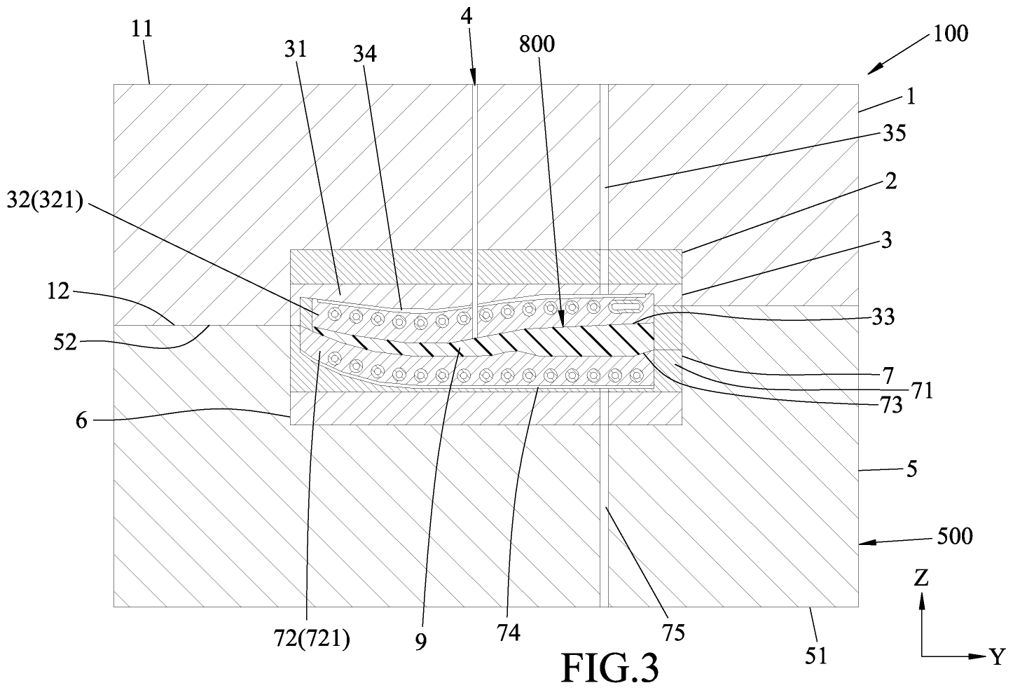

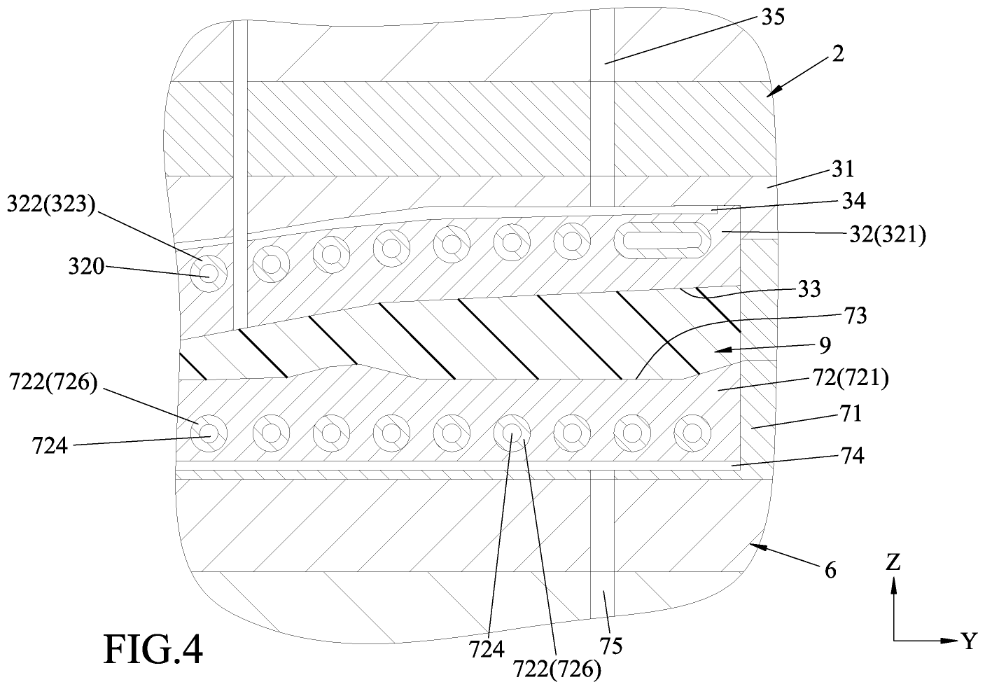

Referring to FIGS. 2 to 5 and FIG. 8, the first porous layer 32 has a porous structure created by three dimensional printing. The first porous layer 32 further includes a first porous main body 321 and at least one first connecting tube 322 formed in the first porous main body 321. In this embodiment, the first porous layer 32 includes one first connecting tube 322. The first porous main body 321 has a porous structure for passage of gas therethrough. It should be noted that although the sectional views of the first porous main body 321 in FIGS. 3, 4 and 8 are schematically shown in only diagonal lines, the first porous main body 321 has the porous structure (i.e., the pores of the porous structure are not shown). The first connecting tube 322 has a solid tube wall 323 that is formed by three dimensional printing, and that defines a first fluid passage 320. Opposite ends of the first connecting tube 322 are respectively connected to the first through holes 13, allowing a liquid supplying device (not shown) to continuously supply a liquid into the first connecting tube 322 through one of the first through holes 13 and to recover the liquid from the other one of the first through holes 13 to achieve liquid circulation in the first fluid passage 320, thereby regulating the temperature of the first inner mold 3.

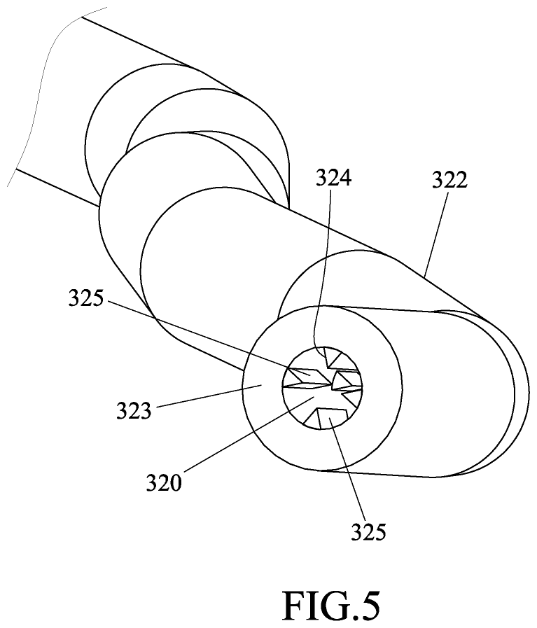

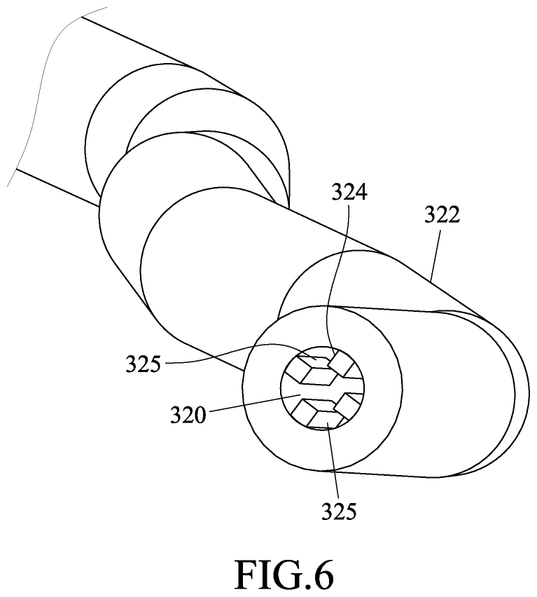

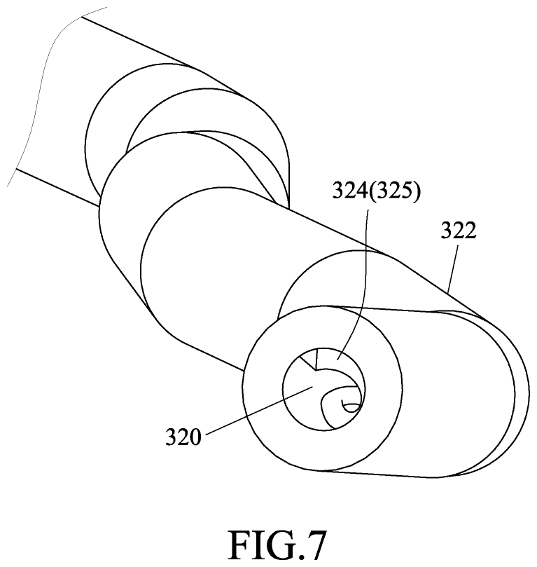

The first connecting tube 322 further has at least one swirling unit 324 that is formed on an inner surface of the solid tube wall 323 of the first connecting tube 322. It should be noted that the first connecting tube 322 may include a plurality of swirling units 324 according to practical requirements. The solid tube wall 323 of the first connecting tube 322 is made of solid steel and formed by three dimensional printing, thereby confining the liquid to flow in the first fluid passage 320 without leaking. The swirling unit 324 of the first connecting tube 322 includes a plurality of protrusion blocks 325 extending from the inner surface of the solid tube wall 323 of the first connecting tube 322. The swirl unit 324 improves thermal convection of the liquid when flowing in the first fluid passage 320. It is worth mentioning that each of the protrusion blocks 325 may have a triangular shape (see FIG. 5), a sheet shape (see FIG. 6), a spiral shape (see FIG. 7) or other shapes, as long as it is capable of improving thermal convection. In this embodiment, the first connecting tube 322 meanders in the first porous main body 321 to provide better temperature regulating function.

Alternatively, the first porous layer 32 may includes a plurality of the first connecting tubes 322. When the size of the first inner mold 3 is larger, the total length of the first connecting tube 322 is also larger, resulting in the need for higher liquid pressure of the liquid supplying device and resulting in greater temperature difference between opposite ends of the first connecting tube 322, which may cause ineffective temperature control. Therefore, multiple first connecting tubes 322 may solve the problems associated with the larger first inner mold 3.

Referring to FIGS. 2 to 4, in this embodiment, the first gas passage 35 may be engaged into a gas supplying device (not shown) through a gas valve (not shown), which regulates the flow rate of the gas supplied into the first gas passage 35. The gas is supplied by the gas supplying device into the first hollow space 34 and the pores of the first porous layer 32 through the first gas passage 35. It should be noted that the extension direction of the first gas passage 35 may be changed according to practical requirements, as long as the first gas passage 35 is able to be connected to the gas supplying device.

The second mold 500 is operable to be connected detachably to the first mold 100 to define cooperatively a cavity 800. The second mold 500 includes a second mold seat 5, a second base plate 6 and a second inner mold 7. The second mold seat 5 has a second outer surface 51 facing away from the first mold 100, and a second inner surface 52 opposite to the second outer surface 51 in the top-bottom direction (Z) and formed with a second groove 521 that receives the second inner mold 7. The second mold seat 5 has two second through holes 53 that are spaced apart in the front-rear direction (Y), that each extend in the left-right direction (X), and that are communicated spatially with the second groove 521. In this embodiment, the second base plate 6 is made of steel.

Referring to FIGS. 2 to 4 and FIG. 8, the second inner mold 7 is made by a three dimensional printing technique from steel powder to be connected to a top side of the second base plate 6, and is received in the second groove 521. The second inner mold 7 includes a second porous layer 72, and a second solid layer 71 that is connected between the second base plate 6 and the second porous layer 72. In this embodiment, the second porous layer 72 has a porosity ranging from 0% to 50%. A periphery of the second porous layer 72 is connected to the second solid layer 71 such that the second solid layer 71 and the second porous layer 72 cooperatively define a second hollow space 74 therebetween. The second hollow space 74 contains air and is used for thermal insulation.

The second mold 500 further has a second gas passage 75 that extends from the second porous layer 72 in a direction away from the second inner mold 7, and that is adapted for the gas to be supplied to the second porous layer 72 therethrough. In this embodiment, the second gas passage 75 extends through the second mold seat 5, the second base plate 6 and the second solid layer 71 of the second inner mold 7 in the top-bottom direction (Z). In this embodiment, the second solid layer 71 is a dense and solid steel plate made by three dimensional printing. Gas and liquid are therefore unable to penetrate the second solid layer 71. The second porous layer 72 includes a second molding surface 73 opposite to the second solid layer 71. In this embodiment, the second inner mold 7 is disposed in the second groove 521 by the second base plate 6, which supports the second inner mold 7 to avoid buckling of the second inner mold 7. However, the second base plate 6 may be omitted according to practical requirements.

In this embodiment, the periphery of the second solid layer 71 has a stepped structure (see FIG. 2). The second porous layer 72 has a porous structure created by three dimensional printing. The second porous layer 72 further includes a second porous main body 721, at least one second connecting tube 722 formed in the second porous main body 721, and at least one third connecting tube 723. The at least one third connecting tube 723 is formed in the second porous main body 721 and surrounds the at least one second connecting tube 722. In this embodiment, the second porous layer 72 includes two second connecting tubes 722, and two third connecting tubes 723. The second porous main body 721 has a porous structure for passage of gas therethrough. It should be noted that although the sectional views of the second porous main body 721 in FIGS. 3, 4 and 8 are schematically shown in only diagonal lines, the second porous main body 721 has the porous structure. The second connecting tubes 722 are aligned in the front-rear direction (Y). Each of the second connecting tubes 722 has a solid tube wall 726 that is formed by three dimensional printing, and that defines a second fluid passage 724. The third connecting tubes 723 are aligned in the left-right direction (X), and surround the cavity 800. Each of the third connecting tubes 723 has a solid tube wall 727 defining a third fluid passage 725. The second connecting tubes 722 and the third connecting tubes 723 have the same structures and functions (i.e., temperature regulation) as the first connecting tube 322. Therefore, detailed structures of the second connecting tubes 722 and the third connecting tubes 723 are not further described for the sake of brevity. In certain embodiments, the second connecting tubes 722 and the third connecting tubes 723 may be connected spatially together, and then connected to the second through holes 53. Alternatively, the number of the second through holes 53 may be changed according to the number of the second connecting tubes 722 and the third connecting tubes 723 to reduce liquid pressure needed to circulate the liquid in the tubes and to reduce temperature difference among the tubes. The number of the second connecting tubes 722 and the third connecting tubes 723 may also be changed according to practical requirements. Moreover, the third connecting tubes 723 may be omitted, as long as the second connecting tubes 722 is capable of achieving the temperature regulating function.

Referring to FIGS. 2 to 4, in this embodiment, the second gas passage 75 may be engaged into the gas supplying device through the gas valve. The gas is supplied by the gas supplying device into the second hollow space 74 and the pores of the second porous layer 72 through the second gas passage 75. It should be noted that the extension direction of the second gas passage 75 may be changed according to practical requirements, as long as the second gas passage 75 is able to be engaged into the gas supplying device.

The first and second gas passages 35, 75 allow the gas to be rapidly filled in the first and second hollow spaces 34, 74, the pores of the first and second porous layers 32, 72 and the cavity 800, thereby reducing manufacturing time. The second gas passage 75 may be omitted according to practical requirements, as long as the first gas passage 35 is capable of effectively supplying the gas into the cavity 800.

The material passage 4 extends through one of the first mold 100 and the second mold 500, and is communicated spatially with the cavity 800 for the supercritical foaming material to be injected into the cavity 800 therethrough. In this embodiment, the material passage 4 extends through the first outer and inner surfaces 11, 12 of the first mold seat 1, the first base plate 2 and the first inner mold 3, and is communicated spatially with the cavity 800.

It is worth mentioning that, in this embodiment, each of the first inner surface 12 of the first mold seat 1 of the first mold 100 and the second inner surface 52 of the second mold seat 5 of the second mold 500 is non-planar, and the first inner surface 12 abuts against the second inner surface 52. Alternatively, each of the first and second inner surfaces 12, 52 may be planar, and the first and second molds 100, 500 may be provided with gas discharge passages.

The process of molding the supercritical foaming material into the foamed shoe element 9 using the molding device of this disclosure is described below.

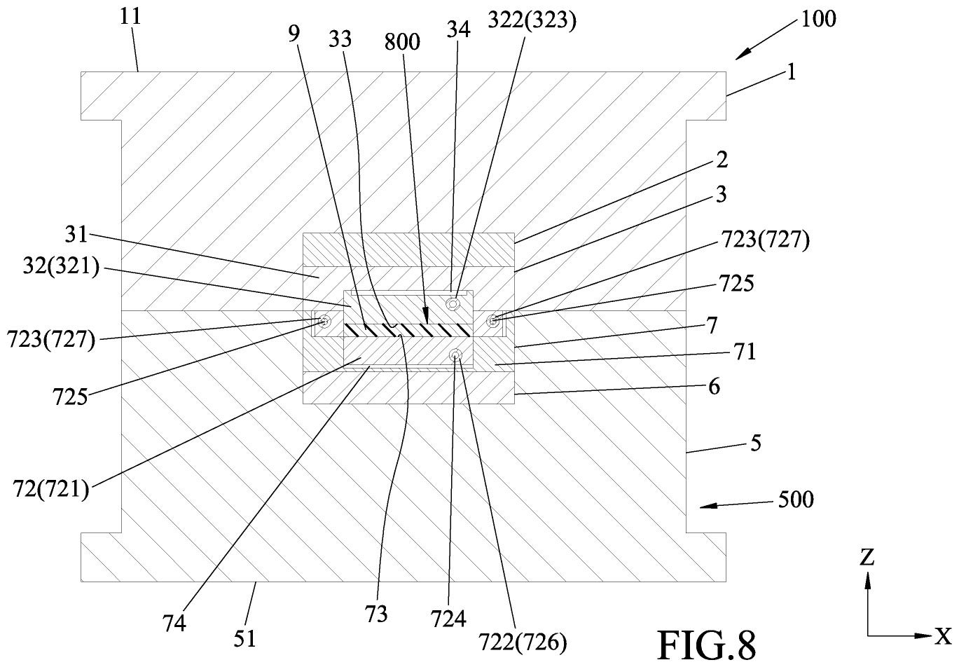

Referring to FIGS. 3 and 8, firstly, the liquid supplying device is used to supply hot water into the first connecting tube 322, the second connecting tubes 722 and the third connecting tubes 723 to heat up the first inner mold 3, the second inner mold 7 and the cavity 800. The first and second hollow spaces 34, 74 prevent heat dissipation from the first and second solid layers 31, 71 when heating with the hot water, thereby improving heating efficiency. The swirling unit 324 (see FIGS. 5 to 7) further improves heating efficiency.

After the cavity 800 is heated to a predetermined working temperature, the gas supplying device is used to supply carbon dioxide (not shown) into the cavity 800 through the first and second gas passages 35, 75.

Afterwards, the supercritical foaming material pre-mixed with supercritical carbon dioxide is injected into the cavity 800 through the material passage 4. During such injection, the carbon dioxide in the cavity 800 is slightly discharged through at least one of the first and second gas passages 35, 75, thereby achieving smooth injection of the supercritical foaming material. By using the gas valve, the carbon dioxide in the cavity 800 maintains a gas pressure that is greater than the supercritical pressure of the supercritical carbon dioxide in the supercritical foaming material, thereby preventing the supercritical foaming material from foaming. The porous structure of the first and second porous layers 32, 72 allows a uniform passage of gas therethrough.

It is worth mentioning that the porosity of the first and second porous layers 32, 72 may be controlled during three dimensional printing to ensure that the supercritical foaming material does not enter the pores of the first and second porous layers 32, 72 during injection.

After the supercritical foaming material is injected into the cavity 800, the gas valve is opened to discharge the carbon dioxide in the cavity 800 through the first and second gas passages 35, 75, allowing the supercritical foaming material to start foaming to be molded into the foamed shoe element 9. It is worth mentioning that the first and second porous layers 32, 72 provide a non-directional discharge of the carbon dioxide from the cavity 800, thereby achieving a uniform discharge of the carbon dioxide.

Then, the liquid supplying device is used to supply cooling water into the first connecting tube 322, the second connecting tubes 722 and the third connecting tubes 723 to cool down the foamed shoe element 9 in the cavity 800. Since the first connecting tube 322, the second connecting tubes 722 and the third connecting tubes 723 are adjacent to the cavity 800, and the swirling unit 324 improves thermal convection, the foamed shoe element 9 can be rapidly cooled, thereby reducing production time. Finally, the first mold 100 is separated from the second mold 500, and the foamed shoe element 9 is removed from the molding device.

In this embodiment, cooling air may be injected to the first and second inner molds 3, 7 through the first and second gas passages 35, 75 to reduce the time necessary for cooling the foamed shoe element 9.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A molding device adapted for molding a supercritical foaming material into a foamed shoe element, said molding device comprising:
a first mold including a first inner mold that includes a first porous layer, said first porous layer including a first porous main body, a first molding surface located at one side of said first porous main body, and at least one first connecting tube formed in said first porous main body and having a solid tube wall defining a first fluid passage, said first mold having a first gas passage that extends from said first porous main body of said first porous layer in a direction away from said first molding surface of said first inner mold and that is adapted for a gas to be supplied into said first porous main body therethrough;
a second mold including a second inner mold that includes a second porous layer, said second porous layer including a second porous main body, a second molding surface located at one side of said second porous main body, facing said first molding surface of said first porous layer of said first inner mold, and cooperating with said first molding surface to define a cavity, and at least one second connecting tube formed in said second porous main body and having a solid tube wall defining a second fluid passage; and
a material passage extending through one of said first mold and said second mold and being spatially communicated with said cavity for the supercritical foaming material to be injected into said cavity therethrough.

2. The molding device as claimed in claim 1, wherein:
said first inner mold of said first mold has a porosity ranging from 0% to 50%; and
said second inner mold of said second mold has a porosity ranging from 0% to 50%.

3. The molding device as claimed in claim 1, wherein said second mold has a second gas passage that extends from said second porous main body of said second porous layer in a direction away from said second molding surface of said second inner mold and that is adapted for a gas to be supplied to said second porous main body therethrough.

4. The molding device as claimed in claim 3, wherein:
said first mold further includes a first mold seat having a first outer surface that faces away from said second mold, and a first inner surface that is opposite to said first outer surface and that is formed with a first groove receiving said first inner mold; and
said second mold further includes a second mold seat that has a second outer surface facing away from said first mold, and a second inner surface opposite to said second outer surface and formed with a second groove receiving said second inner mold.

5. The molding device as claimed in claim 4, wherein:
said first inner mold further includes a first solid layer that is connected between said first mold seat and said first porous layer, and that cooperates with said first porous layer to define a first hollow space therebetween;
said first gas passage extends though said first mold seat and said first solid layer, and spatially communicating said first hollow space;
said second inner mold further includes a second solid layer that is connected between said second mold seat and said second porous layer, and that cooperates with said second porous layer to define a second hollow space therebetween; and
said second gas passage extends though said second mold seat and said second solid layer, and is spatially communicated with said second hollow space.

6. The molding device as claimed in claim 4, wherein said material passage extends through said first outer and inner surfaces of said first mold seat.

7. The molding device as claimed in claim 4, wherein:
said first mold further includes a first base plate that is received in said first groove and that is connected between said first inner surface of said first mold seat and said first inner mold; and
said second mold further includes a second base plate that is received in said second groove and that is connected between said second inner surface of said second mold seat and said second inner mold.

8. The molding device as claimed in claim 4, wherein said second porous layer further includes at least one third connecting tube that is formed in said second porous main body, that surrounds said at least one second connecting tube, and that has a solid tube wall defining a third fluid passage.

9. The molding device as claimed in claim 4, wherein said at least one first connecting tube of said first porous layer of said first inner mold further has at least one swirling unit that is formed on an inner surface of said solid tube wall of said at least one first connecting tube.

10. The molding device as claimed in claim 9, wherein said at least one swirling unit includes a plurality of protrusion blocks extending from said inner surface of said solid tube wall of said at least one first connecting tube.

11. The molding device as claimed in claim 10, wherein each of said protrusion blocks has one of a triangular shape, a sheet shape and a spiral shape.

12. The molding device as claimed in claim 4, wherein:
each of said first inner surface of said first mold seat of said first mold and said second inner surface of said second mold seat of said second mold is non-planar; and
said first inner surface abuts against said second inner surface.
